(19) United States
(12) Patent Application Publication
(10) Pub. No.: US 2026/0273833 A1
(43) Pub. Date: Sep. 17, 2026

(54) TOOL FOR MANUFACTURING A CUSHION IN THE THERMOFORMING PROCESS

(71) Applicants: BAYERISCHE MOTOREN WERKE AKTIENGESELLSCHAFT, München (DE); INDORAMA VENTURES MOBILITY OBERNBURG GMBH, Obernburg (DE)

(72) Inventors: Frank LEYMANN, Elsenfeld (DE); Michael NEIDHÖFER, Mainz (DE); Anna GOLDHOFER, München (DE); Ralph KUSCHMANN, Gräfelfing (DE)

(73) Assignees: BAYERISCHE MOTOREN WERKE AKTIENGESELLSCHAFT, München (DE); INDORAMA VENTURES MOBILITY OBERNBURG GMBH, Obernburg (DE)

(21) Appl. No.: 19/167,635

(22) PCT Filed: Mar. 14, 2024
(86) PCT No.: PCT/EP2024/056850

§ 371 Date: Sep. 22, 2025

(30) Foreign Application Priority Data
Mar. 24, 2023 (DE) 10 2023 107 442.3

(51) Int. Cl. B29C 51/00; B29C 51/18; B29C 51/42; B29C 51/46; B29K 67/00; B29L 31/58

(52) U.S. Cl. CPC B29C 51/004; B29C 51/18; B29C 51/428; B29C 51/46; B29K 2067/00; B29L 2031/58

(57) ABSTRACT

A tool for manufacturing a cushion for a vehicle seat in a thermoforming process. The tool is suitably designed to form a three-dimensional network structure made of fibrous material into the cushion. Further, a method for manufacturing the cushion using the tool and the cushion itself.

The invention relates to a tool for manufacturing a cushion for a vehicle seat with the features of claim 1. The invention further relates to a method for manufacturing the cushion with the features of claim 11 and the cushion itself according to claim 14.

Cushions for vehicle seats are generally known. These cushions are usually made from a polymer foam, which is introduced into a suitable tool and then foamed up during the manufacturing process. For the production of these cushions, a multitude of tools must be used because process times, especially cooling times, are very long. Furthermore, most cushions are made predominantly or entirely from polyurethane (PU). However, PU is hardly recyclable, and typically, PU can only be manufactured from raw materials and not from recycled materials. This results in a poor environmental footprint, which runs counter to the trend towards a positive material cycle. Besides poor recyclability, seats based on PU foam have the major disadvantage that their production is extremely time-consuming. PU foam is generated in the mold by mixing a polyol component and an isocyanate component with a foaming agent. Isocyanates, however, are highly toxic, and it must be ensured that the reagents are fully reacted when the cushion is removed from the mold for safe handling. This requires long resting times after introducing the reagents, which makes the manufacturing of cushions time-consuming. In addition, the previous tools for cushion production generally require the application of a release agent to enable removal of the PU cushion from the tool, adding another process step and further extending process times.

The tool for producing the cushion is advantageously intended to enable the cushion to be made from other, more environmentally friendly materials.

Additionally, the tool allows for a very short process time for manufacturing the cushion, with the cooling time largely eliminated. The resulting cushion exhibits improved recyclability and can additionally be composed partially or wholly of recycled material.

According to the invention, the tool for manufacturing the cushion in a thermoforming process features an integrated heating system and at least one heating channel. The temperature of the tool can be set via at least one measuring device, and the tool has at least one molding element. The molding element allows a three-dimensional network structure made of fibrous material to be reshaped and/or compacted in the thermoforming process, thereby forming the cushion.

A thermoforming process is a method for reshaping thermoplastic materials by applying heat and pressure and/or vacuum. Preferably, the fibrous material of the three-dimensional network structure is pressed against the surface of the hot tool using compressed air. For this, the tool preferably has a sealed air chamber into which forming air can flow. Alternatively or additionally, the tool may have a vacuum pump or vacuum connection so that via vacuum, the fibrous material of the three-dimensional network structure is pressed against the surface of the heated tool. Where thermoforming is reported below, it is synonymous with thermoforming.

Where the term “thermoforming” or “thermo-shaping” (thermoforming in the broader sense) is mentioned below, both are to be understood synonymously.

A three-dimensional network structure made of fibrous material is preferably understood as a textile made from a fleece material, with the textile having a thickness of at least 15 cm. For example, a multi-layered random fiber fleece, in which at least adjacent layers are bonded together, can form such a three-dimensional network structure made of fibrous material. The three-dimensional network structure made of fibrous material may also be a non-layered random fiber fleece or mat, where the fibers are arranged within the textile to achieve a thickness of at least 15 cm. Preferably, the three-dimensional network structure made of fibrous material is BREATHAIR® material, marketed in Europe and the USA by PHP Fibers.

The three-dimensional network structure made of fibrous material is, for example, formed by randomly bonded stitches of a continuous linear structure, where the continuous linear structures are looped to form a three-dimensional structure, held in form by point welding (e.g., via hot air) at intersection points. In one embodiment, the three-dimensional network structure made of fibrous material is self-supporting, which can be compressed by applying external force and forms internal stresses when compressed. These internal stresses ensure that the three-dimensional network structure made of fibrous material springs back to its original form after the external force is removed.

Preferably, the three-dimensional network structure is made predominantly (preferably 90%, even more preferably 100%) from the fibrous material.

In one embodiment, the fibrous material of the three-dimensional network structure consists fully (preferably 90%, even more preferably 100%) or partially (preferably 30%, more preferably 40%, even more preferably 50%, and particularly preferably 70%) of polyester fiber.

In another embodiment, the fibrous material of the three-dimensional network structure consists fully (preferably 90%, even more preferably 100%) or partially (preferably 30%, 40%, 50%, especially 70%) of a thermoplastic elastomer. Thermoplastic elastomers are high molecular weight compounds (“polymers”) that show elastic properties at a temperature of 298 K but can be thermally deformed like thermoplastics at higher temperatures. In contrast to conventional elastomers like rubber (which have low cross-linked macromolecules), thermoplastic elastomers consist of uncross-linked, chain-like macromolecules and can, unlike conventional elastomers, be deformed and melted by heat without chemical decomposition. This means thermoplastic elastomers can be recycled like classic thermoplastics, which is not possible with conventional elastomers.

Typical thermoplastic elastomers belong to known families of thermoplastic polymers, such as polyamides or polyesters. Generally, polyamides are polymers formed by the creation of amide groups between amino groups and carboxylic acid groups of their monomers. The simplest polyamides are created by polymerizing a dicarboxylic acid and a diamine (e.g., adipic acid and hexamethylenediamine for polyamide-6,6) or by polymerizing an aminocarboxylic acid or a lactam (e.g., ε-caprolactam forming polyamide-6). Polyamides formed from one dicarboxylic acid and one diamine or from one lactam or aminocarboxylic acid do not show elastomeric properties. To obtain elastomeric properties, the involvement of more monomers is necessary, which disrupt the formation of very regular and thus crystalline polymer aggregates. Thermoplastic elastomers therefore have small crystalline areas, where neighboring macromolecules are interconnected by non-chemically binding interactions, allowing the network to be melted by heat and re-established upon cooling. This formation of weak cross-linking is possible with copolymers whose chains contain more various monomers than minimally needed for chain building. For polyamides, a thermoplastic elastomer can be built up of a dicarboxylic acid and two or more different diamines or two or more different dicarboxylic acids and one diamine. It is also possible to use two or more different aminocarboxylic acids or two or more different lactams.

The simplest polyesters are created by polymerizing a dicarboxylic acid with a dialcohol. For instance, ethylene glycol and terephthalic acid yield polyethylene terephthalate (PET). Polymerization of a hydroxycarboxylic acid or a lactone is also possible, such as lactic acid yielding polylactide (PLA) or caprolactone yielding polycaprolactone. Polyesters made merely from one dicarboxylic acid and one dialcohol or a hydroxycarboxylic acid or lactone do not show elastomeric properties. To achieve elastomeric properties, as with the mentioned polyamides, the number of monomers must be increased so that two or more dicarboxylic acids and/or two or more dialcohols are used. Equally, two or more hydroxycarboxylic acids or two or more lactones may be used.

Polyester-based thermoplastic elastomers are typically divided into two classes: polyester-ester block copolymers and polyester-ether block copolymers.

Both groups have “hard” and “soft” chain segments. In thermoplastic elastomers from the family of polyester-ester block copolymers, both hard and soft chain segments are formed from polyester units.

Dicarboxylic acids usable for hard and soft chain segments include aromatic acids (terephthalic acid, isophthalic acid, naphthalene-2,6-dicarboxylic acid, naphthalene-2,7-dicarboxylic acid, diphenyl-4,4′-dicarboxylic acid), alicyclic acids (1,4-cyclohexane dicarboxylic acid), and aliphatic acids (succinic acid, adipic acid, sebacic acid, fatty acid dimers). Derivatives like anhydrides or halides can also be used.

For the diol component for hard chain segments, aliphatic diols (1,4-butanediol, ethylene glycol, trimethylene glycol, pentamethylene glycol, hexamethylene glycol), alicyclic diols (1,1-cyclohexane dimethanol, 1,4-cyclohexane dimethanol), and ester-forming derivatives (chlor-, brom-, iodine alkanes) can be applied.

Additionally, so-called polyester diols can be used: oligomers or polymers like polyesters made from dicarboxylic acids and diols or hydroxycarboxylic acids or lactones, where both chain ends contain hydroxyl groups, allowing them to behave like diol units in polyester chains. Polyester diols, e.g., polylactones such as polycaprolactone modified with a diol or a precursor like a halogenalkanol so both ends have hydroxyl groups, generally have an average molar mass of 300 to 5000 g/mol and are usually based on aliphatic polyesters.

Polyester-ester block copolymer embodiments include triblock copolymers containing terephthalic acid and/or naphthalene-2,6-dicarboxylic acid as a dicarboxylic acid, 1,4-butanediol as a diol component, and polylactone as a polyester diol. Polyester-ether copolymers may be based on the same dicarboxylic acids and diols as polyester-ester copolymers. Furthermore, the base may be a polymerized hydroxycarboxylic acid or lactone. In contrast, polyester-ether copolymers contain a polyether diol component as the “soft” chain segment rather than a polyester diol component—for instance, polyalkylene diols like polyethylene glycol, polypropylene glycol, polytetramethylene glycol, or ethylene oxide-propylene oxide copolymers. The average molar mass of the polyether diol component may be between 300 and 5000 g/mol.

Preferably, the inventive tool allows manufacturing the cushion for the vehicle seat from the three-dimensional network structure made of fibrous material with a single tool (the tool described here).

With the integrated heating system, the tool is heatable and preferably has a uniform temperature, with temperature fluctuations within the tool less than 5° C.

According to the invention, the tool has at least one heating channel. Preferably, the tool has more than 10, more preferably more than 20, even more preferably more than 30 heating channels. The heating channels run preferably inside the material of the tool and are fully enclosed by it. The heating channels enable a heating medium to be passed through the tool to heat it. The heating channels may be uniformly distributed or specific zones of the tool may have higher or lower numbers of heating channels. For instance, in areas where strong curvature is desired in the cushion, more heating channels may be provided than in less curved areas. This allows the three-dimensional fibrous material to be heated especially evenly in those places and thus be reshaped more accurately. Advantageously, this enables highly contoured cushions to be produced using only one tool.

One embodiment is a hot air heating system. Using hot air provides especially clean working conditions: even if the hot air system leaks, neither the cushion material (three-dimensional network structure) nor the working environment is contaminated. Moreover, hot air is environmentally friendly.

In another embodiment, heating occurs with steam. Preferably, the tool is heated via the heating channels using steam. Again, it is particularly advantageous that leakage does not soil the fibrous material or the manufacturing facility. One embodiment of the tool has at least one, preferably more than 50, heat discharge openings. Preferably, these openings are directly connected to the heating channels and are open towards the A-side (active side) of the tool. The heat discharge openings help prevent heat accumulation in the tool, thereby avoiding non-uniform heating or overheating that could damage or cause unwanted adhesion of fibrous material to the tool. Opening to the A-side allows excess heat to be safely discharged.

It is particularly preferred if the measuring device, for example the contact thermometer, is connected to a control unit. The control unit can regulate the temperature and/or the amount of heating medium (guided through the heating channels) as a function of the temperature measured by the measuring device. The control unit may form part of the tool or may be a separate device connected to the tool. Furthermore, the control unit can be arranged directly in or on the tool in a form-fitting and/or force-fitting manner. A plurality of control units may also be provided, which may, for example, control different heating channels and/or different heating systems.

Preferably, the tool has at least one, more preferably more than 2, even more than 4 measuring devices. In one embodiment, the device is a contact thermometer, which enables very accurate measurement of the tool's temperature. With more than one measuring device, it can be determined whether the desired temperature distribution is present, as required for processing the three-dimensional network structure. It is especially advantageous if the measuring device, like the contact thermometer, is connected to a control unit. The control unit can preferentially regulate the temperature and/or amount of heating medium (passed through the heating channels) depending on the measured temperature. The control unit may be integrated into the tool or be a separate device. Additionally, multiple control units may be provided, each controlling different heating channels or systems.

Preferably, the measuring device has an accuracy of ±4° C., even more preferably ±2° C., and most preferably ±0.5° C. In one embodiment, the contact thermometer has an accuracy of ±4° C., even more preferably ±2° C., and most preferably ±0.5° C.

In one embodiment, the tool has more than 1, preferably more than 5, most preferably more than 10 molding elements. At least one molding element—a slider in the plurality—is used for shifting the fibrous material of the three-dimensional network structure, changing fiber density per area and/or the outer contour of the material. For example, by shifting the fibrous material with the slider, a bulge can be formed, with thickness greater than the surrounding material, making an elevation. Using the slider can also locally compress the fibrous material, changing fiber density for stiffer regions, thus supporting contours of the cushion. Both fiber density and contour can be modified, for example, forming a bulge with greater thickness and increased fiber density and stiffness compared to the rest. These changes made by the molding elements during cushion formation are preferably permanent and not reversible.

In one embodiment, the molding element is a contour forming part, allowing certain areas of the fibrous three-dimensional network structure to be irreversibly contoured or bent (e.g., bent over an edge and attached on the underside of the forming cushion), without substantially changing fiber density—mainly modifying the outer shape. This deformation is less pronounced than in bulge formation.

Another aspect of the invention relates to a method for manufacturing a cushion through a thermoforming process using a tool as described. Where applicable, details about the tool apply to the method and vice versa.

According to the invention, the method is designed so that the fibrous material—the three-dimensional network structure placed into the tool—is irreversibly reshaped and/or compacted by means of the tool, thereby forming the cushion. Preferably, only a single tool (per claim 1) is used in the method for manufacturing the cushion.

Preferably, production of the cushion from the three-dimensional network structure is achieved without foaming. This means that no polymer foam, especially no PU foam, is used; rather, the cushion for the vehicle seat is formed completely (at least 90%, even better 100%) from the three-dimensional network structure made of fibrous material.

One method embodiment for manufacturing the cushion involves an injection molding process, injection molding step, or injection molding technique.

An injection molding process is understood as all processes where a melt (such as a polymer melt) is injected under pressure into a mold composed of at least two parts, filling it, and solidifying as it cools. The mold is constructed so the two parts seal tightly, preventing leakage of the melt for material saving and uniform shape. Preferably, the injection molding process is used to form a part (clip holder or part thereof) and simultaneously attach it to the cushion (preferably the fibrous three-dimensional network structure).

The injection molding process or step may take place before, after, or simultaneously with the thermoforming process. For example, in a first step clip holders may be attached to the fibrous material of the three-dimensional network structure by injection molding, and in a subsequent step the fibrous material is inserted into the tool for thermoforming. Alternatively, the tool may be designed such that the fibrous material can be inserted and first subjected to injection molding inside the tool and subsequently thermoformed without having to remove it in between. In another embodiment, thermoforming is performed first in the tool, followed by the attachment of clip holders in a separate injection molding process. For this purpose, the shaped fibrous material may either remain in the tool or be removed. In a further embodiment, thermoforming of the fibrous material takes place approximately simultaneously with the injection molding process, while the fibrous material remains in the tool. If the fibrous material remains in the tool after thermoforming, the process time of the injection molding can be advantageously used for cooling of the cushion, thereby reducing the overall manufacturing time.

Keeping the fibrous material in the tool during the injection molding process prior to thermoforming has the advantage that only a single tool is needed for both process steps and that the position of the clips during thermoforming can be managed more reliably. Incorrect or imprecise insertion of fibrous material with clips, which would otherwise lead to poor thermoforming quality in the clip area, is thereby prevented or reduced. Particularly when a part of the clip holder region is to be specially designed in the thermoforming process (for example by a bending-over operation), this may result in an improvement of quality and a reduction of scrap.

The term “clip holder” is understood to mean a fastening element composed of at least one part. The fastening element can form a detachable mechanical connection with another fastening element, the connection being either force-fit, form-fit, or a combination of both. In one embodiment of the clip holder, a hook and/or pin is used, which is gripped or engaged by a clamp as the other fastening element.

The injection molding process or step can occur before, after, or simultaneously with the thermoforming process. For example, a clip holder may first be attached via injection molding to the fibrous network, and, in another step, the material is put into the tool for thermoforming. Alternatively, the tool may be designed so the fibrous material is placed in it, and first injection molding is performed, then thermoforming, all without removing the fibrous material. Another example is first thermoforming, then attachment of a clip holder in a subsequent injection molding step. For the injection molding process, the molded fibrous material can remain in the tool or be removed. In an alternative embodiment, thermoforming and injection molding are conducted approximately simultaneously. If the fibrous material remains in the tool after thermoforming, the injection molding process time can be utilized for cooling the cushion, thus reducing production time. Holding the fibrous material in the tool during injection molding before thermoforming has the advantage of requiring only one tool for both process steps, and the position of the clips during thermoforming is better managed, reducing errors and improving quality, which also lowers scrap. The term “clip holder” refers to a fastening part composed of at least one component, which can make a detachable mechanical connection with another fastening part. The connection can be force-fit, form-fit, or a combination. One embodiment of the clip holder involves a hook and/or pin (which can be gripped or surrounded by a clamp as a second fastening part). Another aspect of the invention concerns a cushion for a vehicle seat produced by the above-described method and tool. The properties and designs for the tool and method also apply for the cushion where relevant.

According to the invention, the cushion is essentially free of polyurethane soft foam. “Essentially free” here means less than 10%, preferably less than 5%, ideally 0% polyurethane soft foam.

In a preferred embodiment, the cushion is essentially free of any polymer foams. Again, “essentially free” means less than 10%, preferably less than 5%, ideally 0% polymer foam.

A cushion with no polyurethane soft foam and/or no polymer foam is particularly environmentally friendly, easy to recycle, and can be made at least partially from recycled material.

In one embodiment, the fibrous material of the three-dimensional network structure for forming the cushion consists of at least 20%, 30%, 40%, 50%, 60%, 70%, 80%, 90%, or 100% recycled material.

The tool and the cushion are described below using figures, which are only exemplary embodiments.

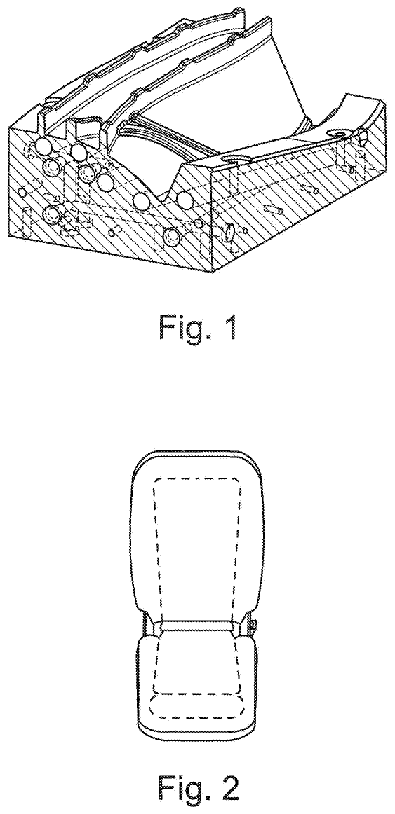

FIG. 1 schematically shows a tool for shaping a backrest section.

FIG. 2 shows a photograph of a cushion formed from a three-dimensional network structure.

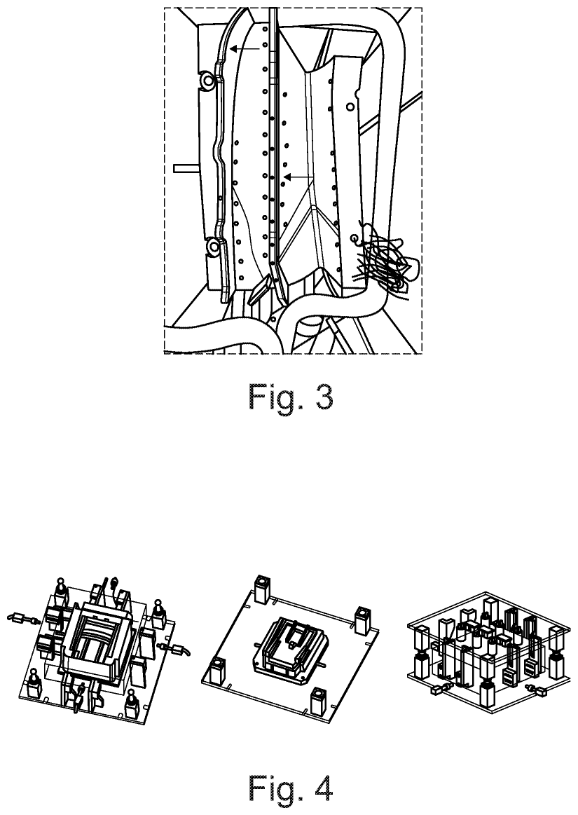

FIG. 3 shows a photograph of a tool for shaping the cushion.

FIG. 4 shows sketches of tools.

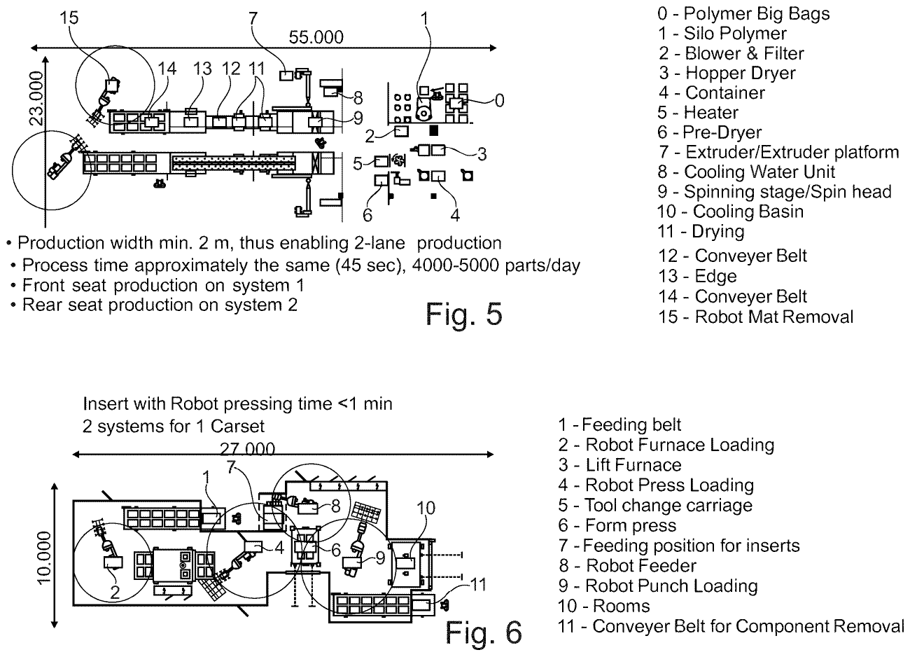

FIG. 5 schematically shows a blank production line for manufacturing the cushion.

Through the preformed semi-finished product (tool), seat shapes (cushions) with different compression hardness can be produced, for example higher compression hardness in bulged portions. The different hardness levels within the component (cushion) are achieved by reshaping and compacting material in the thermoforming process. Deep-drawing tools enable higher contour accuracy. The integration of sliders allows lateral bending of cushion and backrest parts as well as the integration of cover fastening systems without additional material, combined with the integration of injection nozzles for molding clip holders.

The tools have an integrated hot air system, since only a narrow temperature window is available for optimum processability. The reason for this is the open material structure of the three-dimensional network structure. Heating channels were introduced into the tool and air holes were drilled from the A-side. This ensures improved and more uniform heating of the mat material (three-dimensional network structure). The mold is heated with water (steam). The inlet temperature can be set up to about 170° C. The tool temperature is controlled via a contact thermometer and adjusted to 98° C.

Back pressure is reduced by drilling the outlet holes further towards the rear, allowing for more uniform air entry into the material (three-dimensional network structure), which ensures homogeneous irreversible deformation. The contours are depicted more clearly, and the components (cushions) can be easily demolded. An open/close tool enables significantly leaner processes in the production plant, with many foam-specific steps omitted (see FIGS. 5 and 6).

FIG. 6 schematically shows a production line for seat forming for manufacturing the cushion.

The preformed semi-finished product (tool) enables seat shapes (cushions) with different compression hardness, for example, higher compression hardness in bulged areas. The different hardnesses inside the component (cushion) are achieved through reshaping and compaction of material in the thermoforming process. Deep-drawing tools enable greater accuracy of contour. The integration of sliders enables lateral bending of cushion and backrest parts as well as integration of cover fastening systems without material addition, with further integration of injection nozzles for the application of clip holders. The tools have an integrated hot air system because there is only a narrow temperature window for optimal processing, due to the open material structure of the three-dimensional network structure. Heating channels have been introduced into the tool, and air holes bored from the A-side. This achieves better and more uniform heating of the mat material (three-dimensional network structure). The form is heated with water (steam). The inlet temperature is adjustable up to about 170° C. The tool temperature is controlled via a contact thermometer set to 98° C. Back-pressure is reduced by drilling outlet holes further behind, allowing for more even intake of air into the material (three-dimensional network structure), ensuring uniform irreversible deformation. Contours are shown more clearly, and the components (cushions) can be easily removed from the tool. The open/close tool system enables significantly streamlined processes in the factory, with many foam-specific steps omitted (see FIGS. 5 and 6).

1. Tool for manufacturing a cushion for a vehicle seat for persons in a thermoforming process, with an integrated heating system and at least one heating channel, where the temperature of the tool is adjustable via a measuring device, and with at least one molding element, by which a three-dimensional network structure of fibrous material placed in the tool can be reshaped and/or compacted to form the cushion.

2. Tool according to claim 1, where the heating system is a hot air system.

3. Tool according to claim 1, where the tool is heatable with steam via at least one heating channel.

4. Tool according to claim 1, where the tool has heat discharge openings.

5. Tool according to claim 4, where the heat discharge openings are at least opened towards the A-side of the tool.

6. Tool according to claim 1, where the measuring device is a contact thermometer.

7. Tool according to claim 6, where the contact thermometer has an accuracy of ±4° C.

8. Tool according to claim 1, where the at least one molding element is at least one slider, whereby at least parts of the three-dimensional network structure of fibrous material can be irreversibly formed into bulged parts and/or compacted.

9. Tool according to claim 1, where the at least one molding element is at least one contour-forming component, whereby at least parts of the three-dimensional network structure of fibrous material can be irreversibly contoured and/or bent.

10. Tool according to claim 1, where the three-dimensional network structure of fibrous material predominantly consists of polyester fiber.

11. Method for manufacturing a cushion for a vehicle seat for persons by a thermoforming process using the tool according to claim 1, where the inserted three-dimensional network structure of fibrous material is irreversibly reshaped and/or compacted by means of the tool to form the cushion.

12. Method according to claim 11, where the reshaping and/or compaction of the inserted three-dimensional network structure of fibrous material to form the cushion occurs without foaming.

13. Method according to claim 11, where before, after, or during the thermoforming process for manufacturing the cushion, an additional injection molding process occurs.

14. Cushion for a vehicle seat for persons, manufactured according to a process as in claim 11, where the cushion is essentially free of polyurethane soft foam.
